(19) United States
(12) Patent Application Publication
(10) Pub. No.: US 2023/0307164 A1
(43) Pub. Date: Sep. 28, 2023

(54) MULTILAYER COIL COMPONENT

(71) Applicant: TDK Corporation., Tokyo (JP)

(72) Inventors: Munehiro TAKAKU, Tokyo (JP); Nobuyuki OKUZAWA, Tokyo (JP); Kazuya TOBITA, Tokyo (JP); Teruhiro MITSUYASU, Tokyo (JP)

(73) Assignee: TDK Corporation., Tokyo (JP)

(21) Appl. No.: 18/166,262

(22) Filed: Feb. 8, 2023

(30) Foreign Application Priority Data
Mar. 25, 2022 (JP) 2022-050221

(51) Int. Cl. H01F 5/04; H01F 27/29; H01F 27/28

(52) U.S. Cl. CPC H01F 5/04; H01F 27/2804; H01F 27/292

(57) ABSTRACT

Provided is a multilayer coil component including an element body, a first terminal electrode, a second terminal electrode, a coil, a first connecting conductor, and a second connecting conductor, wherein a length of each of the first connecting conductor and the second connecting conductor in a first direction is longer than lengths of pillar portions connected to the first connecting conductor and the second connecting conductor in the first direction and equal to or less than lengths of the first terminal electrode and the second terminal electrode in the first direction.

### TECHNICAL FIELD

The present invention relates to a multilayer coil component.

### BACKGROUND

As a conventional multilayer coil component, for example, a multilayer coil component described in Patent Document 1 (Japanese Unexamined Patent Publication No. 2015-141945) is known. The multilayer coil component described in Patent Document 1 includes: an element body that has a pair of end surfaces opposite each other in a first direction, a mounting surface and a main surface opposite each other in a second direction, and a pair of side surfaces opposite each other in a third direction; a coil disposed in the element body; and a pair of terminal electrodes disposed on the mounting surface of the element body, wherein the coil is configured to include first wiring portions disposed on the main surface side, second wiring portions disposed on the mounting surface side, and connecting portions that extend in the second direction and connect the first wiring portions to the second wiring portions.

### SUMMARY

In a conventional multilayer coil component, the connecting portions have a constant width (length) over the entire length in an extending direction thereof. In this configuration, in the conventional multilayer coil component, the terminal electrodes are connected to end portions of the connecting portions constituting the coil. In the conventional multilayer coil component, for example, when an external force is applied to the terminal electrodes, stress is applied to connection portions between the end portions of the connecting portions and the terminal electrodes, which may disconnect the terminal electrodes from the connecting portions. Thus, connection between the terminal electrodes and the coil (connecting portions) becomes unstable, or electrical connection between the terminal electrodes and the coil is broken. As a result, characteristics of the multilayer coil component may deteriorate or the multilayer coil component may cease to function.

An object of one aspect of the present disclosure is to provide a multilayer coil component of which reliability can be improved.

A multilayer coil component according to one aspect of the present disclosure includes: an element body that includes a pair of end surfaces opposite each other in a first direction, a mounting surface and a main surface opposite each other in a second direction, and a pair of side surfaces opposite each other in a third direction; a pair of terminal electrodes disposed on the mounting surface of the element body to be separated from each other in the first direction; a coil that is disposed in the element body and electrically connected to the pair of terminal electrodes; and connecting conductors connecting end portions of the coil to the terminal electrodes, wherein the coil includes first wiring portions disposed on the main surface side, second wiring portions disposed on the mounting surface side, and connecting portions that extend in the second direction and connect the first wiring portions to the second wiring portions, in the connecting portions of which one end portions are connected to the first wiring portions and the other end portions are electrically connected to the terminal electrodes, the connecting conductors are connected between the other end portions of the connecting portions and the terminal electrodes, and lengths of the connecting conductors in the first direction are longer than lengths of the connecting portions connected to the connecting conductors in the first direction and are equal to or less than lengths of the terminal electrodes in the first direction.

In the multilayer coil component according to one aspect of the present disclosure, the lengths of the connecting conductors in the first direction are longer than the lengths of the connecting portions connected to the connecting conductors in the first direction and are equal to or less than the lengths of the terminal electrodes in the first direction. Thus, in the multilayer coil component, since the lengths of the connecting conductors in the first direction are longer than the lengths of the connecting portions, contact areas between the terminal electrodes and the connecting conductors can be increased. For that reason, in the multilayer coil component, bonding strength between the terminal electrodes and the connecting conductors can be improved. Thus, disconnection between the terminal electrodes and the connecting conductors can be inhibited. As a result, the reliability of the multilayer coil component can be improved.

In one embodiment, when viewed in the second direction, each of the plurality of second wiring portions may include a first portion that includes a region overlapping the corresponding connecting portion, extends in the first direction, and is located closer to one end surface, a second portion that includes a region overlapping the corresponding connecting portion, extends in the first direction, and is located closer to the other end face, and a third portion that connects the first portion to the second portion and is inclined with respect to the first direction, and lengths of the first portion and the second portion in the first direction may be longer than the lengths of the connecting conductors in the first direction. The second wiring portions and the connecting conductors are disposed at continuous positions in the second direction. In this configuration, the lengths in the first direction of the first portion and the second portion extending in the first direction are longer than the lengths of the connecting conductors in the first direction. In this configuration, since a state in which the connecting conductors and the third portions are in close proximity to each other in the second direction can be prevented, it is possible to inhibit occurrence of a short circuit between the connecting conductors and the third portions. For that reason, the reliability of the multilayer coil component can be improved.

In one embodiment, linking conductors disposed at the same positions as the second wiring portions in the second direction between the connecting conductors and the connecting portions electrically connected to the connecting conductors may be provided, and lengths of the linking conductors in the first direction may be equal to or less than the lengths of the connecting conductors in the first direction and equal to or greater than the lengths of the connecting portions in the first direction. In this configuration, the lengths of the linking conductors can be set within the range between the lengths of the connecting conductors and the lengths of the connecting portions. Thus, in the multilayer coil component, contact areas between the connecting conductors and the linking conductors can be increased. For that reason, in the multilayer coil component, bonding strength between the connecting conductors and the linking conductors can be improved. Thus, it is possible to inhibit occurrence of disconnection between the connecting conductors and the linking conductors. As a result, the reliability of the multilayer coil component can be improved.

In one embodiment, lengths of the connecting conductors in the third direction may be equal to or greater than lengths of the connecting portions in the third direction. In this configuration, contact areas between the terminal electrodes and the connecting conductors can be further increased.

According to one aspect of the present invention, the reliability can be improved.

### BRIEF DESCRIPTION OF THE DRAWINGS

FIG. 1 is a perspective view of a multilayer coil component according to one embodiment.

FIG. 2 is a side view of the multilayer coil component.

FIG. 3 is a side view of the multilayer coil component.

FIG. 4 is a diagram in which the multilayer coil component is viewed from a mounting surface side thereof.

FIG. 5 is an end view of the multilayer coil component.

### DETAILED DESCRIPTION

A preferred embodiment of the present disclosure will be described in detail below with reference to the accompanying drawings. Also, in the description of the drawings, the same or corresponding elements will be denoted by the same reference numerals, and repeated description thereof will be omitted.

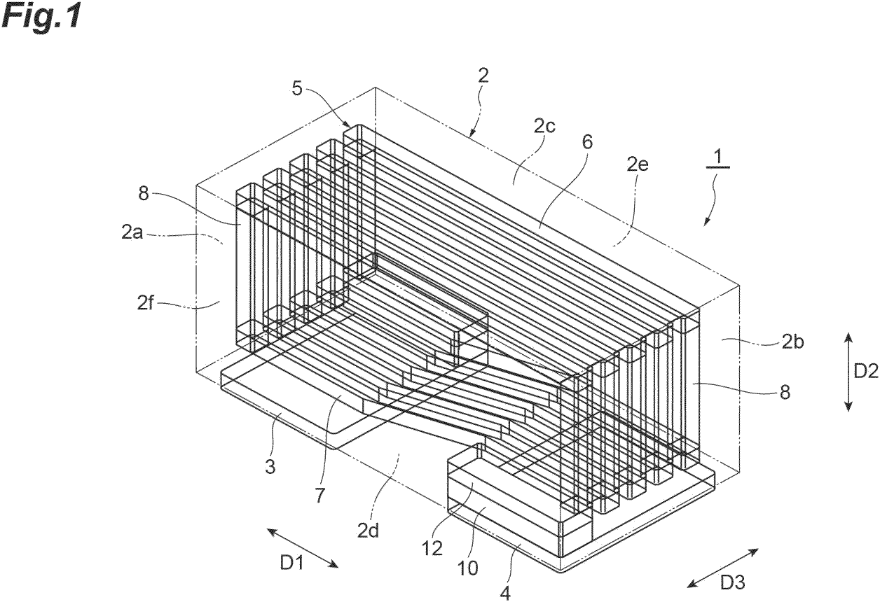

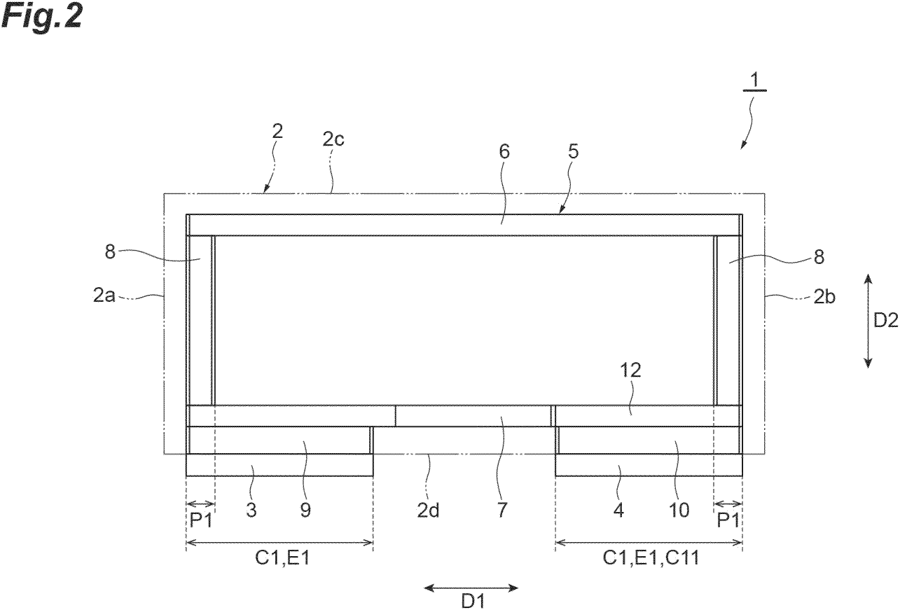

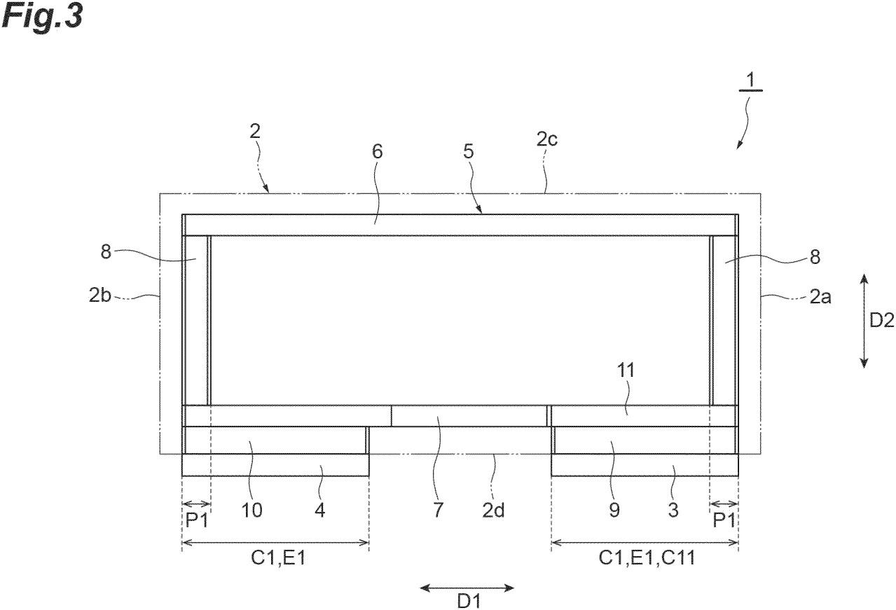

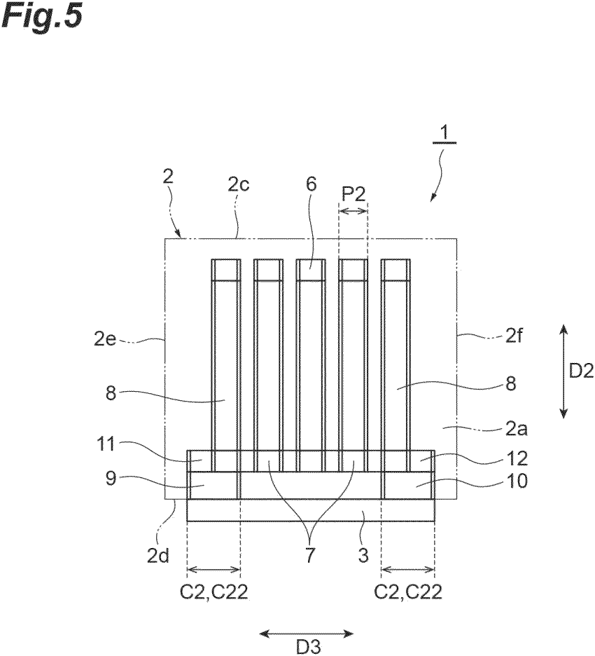

A multilayer coil component according to the present embodiment will be described with reference to FIG. 1. FIG. 1 is a perspective view of a multilayer coil component according to one embodiment. As shown in FIG. 1, the multilayer coil component 1 includes an element body 2, a first terminal electrode 3, a second terminal electrode 4, a coil 5, a first connecting conductor 9 (see FIG. 2), a second connecting conductor 10, a first linking conductor 11 (see FIGS. 3 and 5), and a second linking conductor 12. In FIG. 1, for convenience of explanation, the element body 2 is indicated by a two-dot chain line, and the coil 5 is shown transparently. Also in FIGS. 2 to 5, for convenience of explanation, the element body 2 is indicated by a two-dot chain line, the coil 5 is shown transparently, and the first terminal electrode 3 and the second terminal electrode 4 are shown by broken lines.

The element body 2 has a rectangular parallelepiped shape. The rectangular parallelepiped shape may be a rectangular parallelepiped shape with chamfered corner portions and edge portions or a rectangular parallelepiped shape with rounded corner portions and edge portions. The element body 2 has, as outer surfaces, a pair of end surfaces 2a and 2b, a pair of main surfaces 2c and 2d, and a pair of side surfaces 2e and 2f. The end surfaces 2a and 2b are opposite each other. The main surfaces 2c and 2d are opposite each other. The side surfaces 2e and 2f are opposite each other. Hereinafter, a direction in which the end surfaces 2a and 2b are opposite each other will be defined as a first direction D1, a direction in which the main surfaces 2c and 2d are opposite each other will be defined as a second direction D2, and a direction in which the side surfaces 2e and 2f are opposite each other will be defined as a third direction D3. The first direction D1, the second direction D2, and the third direction D3 are substantially orthogonal to each other.

The end surfaces 2a and 2b extend in the second direction D2 to connect the main surfaces 2c and 2d to each other. The end surfaces 2a and 2b also extend in the third direction D3 to connect the side surfaces 2e and 2f to each other. The main surfaces 2c and 2d extend in the first direction D1 to connect the end surfaces 2a and 2b to each other. The main surfaces 2c and 2d also extend in the third direction D3 to connect the side surfaces 2e and 2f to each other. The side surfaces 2e and 2f extend in the first direction D1 to connect the end surfaces 2a and 2b to each other. The side surfaces 2e and 2f also extend in the second direction D2 to connect the main surfaces 2c and 2d to each other.

The main surface 2d is a mounting surface and, for example, is a surface that faces another electronic device (not shown) (for example, a circuit board or a multilayer electronic component) when the multilayer coil component 1 is mounted on the other electronic device. The end surfaces 2a and 2b are surfaces continuous from the mounting surface (that is, the main surface 2d).

A length of the element body 2 in the first direction D1 is longer than a length of the element body 2 in the second direction D2 and a length of the element body 2 in the third direction D3. The length of the element body 2 in the second direction D2 is shorter than the length of the element body 2 in the third direction D3. That is, in the present embodiment, the end surfaces 2a and 2b, the main surfaces 2c and 2d, and the side surfaces 2e and 2f have rectangular shapes. The length of the element body 2 in the second direction D2 may be equal to the length of the element body 2 in the third direction D3, or may be longer than the length of the element body 2 in the third direction D3.

Also, in the present embodiment, “equal” may be, in addition to being equal, equal to a value including a slight difference or a manufacturing error within a preset range. For example, when a plurality of values are within ±5% of the mean of the plurality of values, they are defined as being equal.

The element body 2 is formed by laminating a plurality of element body layers (not shown) in the second direction D2. That is, the laminating direction in the element body 2 is the second direction D2. In the actual element body 2, the plurality of element body layers may be integrated to such an extent that boundaries between the layers are invisible, or may be integrated such that the boundaries between the layers are visible.

The element body layer is a resin layer. Materials of the element body layer include at least one selected from, for example, a liquid crystal polymer, a polyimide resin, crystalline polystyrene, an epoxy-based resin, an acryl-based resin, a bismaleimide-based resin, and a fluorine-based resin. The element body layer contains a filler. The filler is, for example, an inorganic filler. As the inorganic filler, for example, silica can be exemplified. Also, the element body layer may not contain the filler.

Also, the element body layer may be configured to contain a magnetic material. The magnetic material of the element body layer includes, for example, a Ni—Cu—Zn—based ferrite material, a Ni—Cu—Zn—Mg—based ferrite material, or a Ni—Cu—based ferrite material. The magnetic material of the element body layer may contain, for example, an Fe alloy. The element body layer may contain, for example, a non-magnetic material. The non-magnetic material of the element body layer includes, for example, a glass-ceramic material or a dielectric material.

Each of the first terminal electrode 3 and the second terminal electrode 4 is provided on the element body 2. Each of the first terminal electrode 3 and the second terminal electrode 4 is disposed on the main surface 2d of the element body 2. The first terminal electrode 3 and the second terminal electrode 4 are provided on the element body 2 to be separated from each other in the first direction D1. Specifically, the first terminal electrode 3 is disposed on the end surface 2a side of the element body 2. The second terminal electrode 4 is disposed on the end surface 2b side of the element body 2.

Each of the first terminal electrode 3 and the second terminal electrode 4 has a rectangular shape (quadrangular shape). The first terminal electrode 3 and the second terminal electrode 4 have the same size (dimension). Each of the first terminal electrode 3 and the second terminal electrode 4 is disposed such that each side thereof extends in the first direction D1 or the third direction D3. The first terminal electrode 3 and the second terminal electrode 4 also protrude from the main surface 2d. That is, in the present embodiment, surfaces of each of the first terminal electrode 3 and the second terminal electrode 4 are not flush with the main surface 2d. The first terminal electrode 3 and the second terminal electrode 4 are made of a conductive material (for example, Cu).

Each of the first terminal electrode 3 and the second terminal electrode 4 may be provided with a plating layer (not shown) containing, for example, Ni, Sn, Au, or the like by electrolytic plating or electroless plating. The plating layer may have, for example, a Ni plating film that contains Ni and covers the first terminal electrode 3 and the second terminal electrode 4, and an Au plating film that contains Au and covers the Ni plating film.

The coil 5 is disposed in the element body 2. The coil 5 has a plurality of first wiring portions 6, a plurality of second wiring portions 7, and a plurality of pillar portions (connecting portions) 8. The coil 5 is configured by electrically connecting the first wiring portions 6, the second wiring portions 7, and the pillar portions 8 to each other. A coil axis of the coil 5 is provided in the third direction D3. The plurality of first wiring portions 6, the plurality of second wiring portions 7, and the plurality of pillar portions 8 are made of a conductive material (for example, Cu). The first wiring portions 6, the second wiring portions 7, and the pillar portions 8 are disposed to be separated from the end surfaces 2a and 2b, the main surfaces 2c and 2d, and the side surfaces 2e and 2f.

Each of the first wiring portions 6 is disposed on the main surface 2c side of the element body 2. Each of the first wiring portions 6 extends in the first direction D1. Each of the first wiring portions 6 connects two pillar portions 8 to each other. Each of the first wiring portions 6 spans over two pillar portions 8. One end portions of the first wiring portions 6 in an extending direction thereof (end portions on the end surface 2a side) are connected to one end portions of the pillar portions 8 (end portions on the main surface 2c side). The other end portions of the first wiring portions 6 in the extending direction (end portions on the end surface 2b side) are connected to one end portions of the pillar portions 8.

Each of the second wiring portions 7 is disposed on the main surface 2d (mounting surface) side of the element body 2. Each of the second wiring portions 7 extends in the first direction D1. Each of the second wiring portions 7 connects two pillar portions 8 to each other. Each of the second wiring portions 7 spans over two pillar portions 8. One end portions of the second wiring portions 7 in an extending direction thereof (end portions on the end surface 2a side) are connected to the other end portions of the pillar portions 8 (end portions on the main surface 2d side). The other end portions of the second wiring portions 7 in the extending direction (end portions on the end surface 2b side) are connected to the other end portions of the pillar portions 8. The number of the plurality of second wiring portions 7 is one less than that of the plurality of first wiring portions 6. That is, in a case in which the number of the first wiring portions 6 is n, the number of the second wiring portions 7 is n-1.

The second wiring portions 7 have first portions 7a, second portions 7b, and third portions 7c. When viewed in the second direction D2, the first portions 7a include regions overlapping the corresponding pillar portions 8 and are located closer to the end surface 2a. The first portions 7a extend in the first direction D1. When viewed in the second direction D2, the second portions 7b include regions overlapping the corresponding pillar portions 8 and are located closer to the end surface 2b. The second portions 7b extend in the first direction D1. The third portions 7c connect the first portions 7a to the second portions 7b. The third portions 7c are inclined with respect to the first direction D1 when viewed in the second direction D2.

The pillar portions 8 are disposed on the end surface 2a side and the end surface 2b side of the element body 2. Each of the pillar portions 8 extends in the second direction D2. The pillar portions 8 connect the first wiring portions 6 to the second wiring portions 7. One end portions of the pillar portions 8 are connected to one end portions and the other end portions of the first wiring portions 6. The other end portions of the pillar portions 8 are connected to one end portions and the other end portions of the second wiring portions 7. One end portion of one of the plurality of pillar portions 8 is connected to one end portion of the first wiring portion 6 and the other end portion is connected to the first linking conductor 11. One end portion of one of the plurality of pillar portions 8 is connected to the other end portion of the first wiring portion 6 and the other end portion is connected to the second linking conductor 12.

The first connecting conductor 9 electrically connects the first terminal electrode 3 to one end portion of the coil 5. The first connecting conductor 9 is electrically connected to the other end portion of the pillar portion 8 of the coil 5. The first connecting conductor 9 is made of a conductive material (for example, Cu). The first connecting conductor 9 has a rectangular parallelepiped shape. When viewed in the second direction D2, the first connecting conductor 9 is disposed such that its long sides extend in the first direction D1 and its short sides extend in the third direction D3. An end of the first connecting conductor 9 on the side surface 2e side coincides with an end of the first terminal electrode 3 on the side surface 2e side. An end of the first connecting conductor 9 on the end surface 2a side coincides with an end of the first terminal electrode 3 on the end surface 2a side.

The second connecting conductor 10 electrically connects the second terminal electrode 4 to the other end portion of the coil 5. The second connecting conductor 10 is electrically connected to the other end portion of the pillar portion 8 of the coil 5. The second connecting conductor 10 is made of a conductive material (for example, Cu). The second connecting conductor 10 has a rectangular parallelepiped shape. The second connecting conductor 10 is disposed such that its long sides extend in the first direction D1 and its short sides extend in the third direction D3 when viewed in the second direction D2. An end of the second connecting conductor 10 on the side surface 2f side coincides with an end of the second terminal electrode 4 on the side surface 2f side. An end of the second connecting conductor 10 on the end surface 2b side coincides with an end of the second terminal electrode 4 on the end surface 2b side.

The first linking conductor 11 connects the first connecting conductor 9 to the other end portion of the pillar portion 8 of the coil 5. The first linking conductor 11 is disposed between the first connecting conductor 9 and the pillar portion 8. The first linking conductor 11 is disposed at the same position as the second wiring portions 7 in the second direction D2. The first linking conductor 11 is made of a conductive material (for example, Cu). The first linking conductor 11 has a rectangular parallelepiped shape. When viewed from the second direction D2, the first linking conductor 11 is disposed such that its long sides extend in the first direction D1 and its short sides extend in the third direction D3. An end of the first linking conductor 11 on the side surface 2e side coincides with an end of the first connecting conductor 9 on the side surface 2e side. An end of the first linking conductor 11 on the end surface 2a side coincides with an end of the first connecting conductor 9 on the end surface 2a side.

The second linking conductor 12 connects the second connecting conductor 10 to the other end portion of the pillar portion 8 of the coil 5. The second linking conductor 12 is disposed between the second connecting conductor 10 and the pillar portion 8. The second linking conductor 12 is disposed at the same position as the second wiring portions 7 in the second direction D2. The second linking conductor 12 is made of a conductive material (for example, Cu). The second linking conductor 12 has a rectangular parallelepiped shape. When viewed from the second direction D2, the second linking conductor 12 is disposed such that its long sides extend in the first direction D1 and its short sides extend in the third direction D3. An end of the second linking conductor 12 on the side surface 2f side coincides with an end of the second connecting conductor 10 on the side surface 2f side. An end of the second linking conductor 12 on the end surface 2b side coincides with an end of the second connecting conductor 10 on the end surface 2b side.

Next, dimensions of each portion of the multilayer coil component 1 will be described. As shown in FIGS. 2, 3, or 4, a length C1 of the first connecting conductor 9 in the first direction D1 is longer than a length P1 of the pillar portion 8 connected to the first connecting conductor 9 in the first direction D1 and equal to or less than a length E1 of the first terminal electrodes 3 in the first direction D1 (P1<C1<E1). In the present embodiment, the length C1 of the first connecting conductor 9 in the first direction D1 is longer than the length P1 of the pillar portion 8 connected to the first connecting conductor 9 in the first direction D1, and the same as the length E1 of each of the first terminal electrodes 3 in the first direction D1 (P1<C1=E1).

The length C1 of the second connecting conductor 10 in the first direction D1 is longer than the length P1 of the pillar portion 8 connected to the second connecting conductor 10 in the first direction D1 and equal to or less than the length E1 of the second terminal electrode 4 in the first direction D1 (P1<C1<E1). In the present embodiment, the length C1 of the second connecting conductor 10 in the first direction D1 is longer than the length P1 of the pillar portion 8 connected to the second connecting conductor 10 in the first direction D1 and the same as the length E1 of the second terminal electrode 4 in the first direction D1 (P1<C1=E1).

As shown in FIG. 3, a length C11 of the first linking conductor 11 in the first direction D1 is equal to or less than the length C1 of the first connecting conductor 9 in the first direction D1 and equal to or greater than the length P1 of the pillar portion 8 in the first direction D1 (P1≤C11≤C1). In the present embodiment, the length C11 of the first linking conductor 11 in the first direction D1 is the same as the length C1 of the first connecting conductor 9 in the first direction D1 and longer than the length P1 of the pillar portion 8 in the first direction D1 (P1<C11=C1).

As shown in FIG. 2, the length C11 of the second linking conductor 12 in the first direction D1 is equal to or less than the length C1 of the second connecting conductor 10 in the first direction D1 and equal to or greater than the length P1 of the pillar portion 8 in the first direction D1 (P1<C11<C1). In the present embodiment, the length C11 of the second linking conductor 12 in the first direction D1 is the same as the length C1 of the second connecting conductor 10 in the first direction D1 and longer than the length P1 of the pillar portion 8 in the first direction D1 (P1<C11=C1).

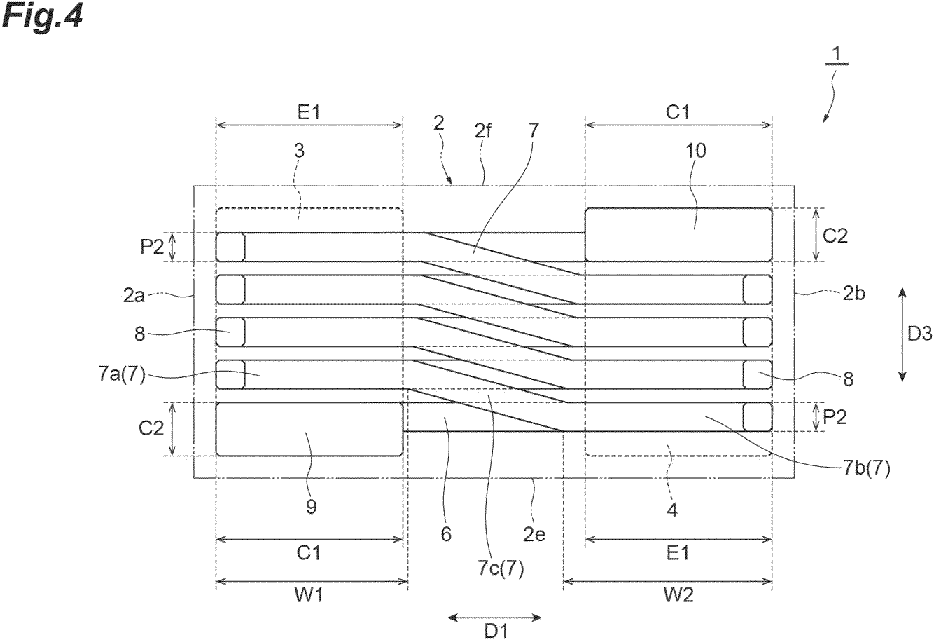

As shown in FIGS. 4 and 5, a length C2 of the first connecting conductor 9 in the third direction D3 is equal to or greater than a length P2 of the pillar portion 8 connected to the first connecting conductor 9 in the third direction D3 (C2≥P2). The length C2 of the second connecting conductor 10 in the third direction D3 is equal to or greater than the length P2 of the pillar portion 8 connected to the second connecting conductor 10 in the third direction D3 (C2≥P2).

As shown in FIG. 5, a length C22 of the first linking conductor 11 in the third direction D3 is greater than or equal to the length P2 of the pillar portion 8 connected to the first connecting conductor 9 in the third direction D3 (C22≥P2). In the present embodiment, the length C22 of the first linking conductor 11 in the third direction D3 is the same as the length C2 of the first connecting conductor 9 in the third direction D3 (C22=C2). The length C2 of the second linking conductor 12 in the third direction D3 is equal to or greater than the length P2 of the pillar portion 8 connected to the second connecting conductor 10 in the third direction D3 (C22≥P2). In the present embodiment, the length C22 of the second linking conductor 12 in the third direction D3 is the same as the length C2 of the second connecting conductor 10 in the third direction D3 (C22=C2).

As shown in FIG. 4, a length W1 of the first portion 7a of the second wiring portion 7 in the first direction D1 is longer than the length C1 of the first connecting conductor 9 in the first direction D1 (W1>C1). A length W2 of the second portion 7b of the second wiring portion 7 in the first direction D1 is longer than the length C1 of the second connecting conductor 10 in the first direction D1 (W2>C1).

As described above, in the multilayer coil component 1 according to the present embodiment, the length C1 of the first connecting conductor 9 (second connecting conductor 10) in the first direction D1 is longer than the length P1 of the pillar portion 8 connected to the first connecting conductor 9 (second connecting conductor 10) in the first direction D1 and equal to or less than the length E1 of the first terminal electrode 3 (second terminal electrode 4) in the first direction D1 (P1<C1≤E1). In this way, in the multilayer coil component 1, since the length of the first connecting conductor 9 (second connecting conductor 10) in the first direction D1 is longer than the length of the pillar portion 8, a contact area between the first terminal electrode 3 (second terminal electrode 4) and the first connecting conductor 9 (second connecting conductor 10) can be increased. For that reason, in the multilayer coil component 1, bonding strength between the first terminal electrode 3 (second terminal electrode 4) and the first connecting conductor 9 (second connecting conductor 10) can be improved. Thus, it is possible to inhibit occurrence of disconnection between the first terminal electrode 3 (second terminal electrode 4) and the first connecting conductor 9 (second connecting conductor 10). As a result, reliability of the multilayer coil component 1 can be improved.

In the multilayer coil component 1 according to the present embodiment, each of the plurality of second wiring portions 7 has the first portion 7a, the second portion 7b, and the third portion 7c. In the multilayer coil component 1, the length W1 of the first portion 7a in the first direction D1 is longer than the length C1of the first connecting conductor 9 in the first direction D1 (W1>C1), and the length W2 of the second portion 7b in the first direction D1 is longer than the length C1 of the second connecting conductor 10 in the first direction D1 (W2>C1). The second wiring portions 7 and each of the first connecting conductor 9 and the second connecting conductor 10 are disposed at continuous positions in the second direction D2. In this configuration, since a state in which each of the first connecting conductor 9 and the second connecting conductor 10 and the third portions 7c are in close proximity to each other in the second direction D2 can be prevented, it is possible to inhibit occurrence of a short circuit between each of the first connecting conductor 9 and the second connecting conductor 10 and the third portions 7c. For that reason, the reliability of the multilayer coil component 1 can be improved.

The multilayer coil component 1 according to the present embodiment includes the first linking conductor 11 and the second linking conductor 12. The length C11 of first linking conductor 11 (second linking conductor 12) in first direction D1 is equal to or less than the length C1 of the first connecting conductor 9 (second connecting conductor 10) in the first direction D1 and equal to or greater than the length P1 of the pillar portion 8 in the first direction D1 (P1≤C11≤C1). In this configuration, the length C11 of the first linking conductor 11 (second linking conductor 12) can be set within the range between the length C1of the first connecting conductor 9 (second connecting conductor 10) and the length P1 of the pillar portion 8. Thus, in the multilayer coil component 1, the contact area between the first connecting conductor 9 (second connecting conductor 10) and the first linking conductor 11 (second linking conductor 12) can be increased. For that reason, in the multilayer coil component 1, bonding strength between the first connecting conductor 9 (second connecting conductor 10) and the first linking conductor 11 (second linking conductor 12) can be increased. Thus, in the multilayer coil component 1, it is possible to inhibit occurrence of disconnection between the first connecting conductor 9 (second connecting conductor 10) and the first linking conductor 11 (second linking conductor 12). As a result, the reliability of the multilayer coil component 1 can be improved.

In the multilayer coil component 1, the length C11 of the first linking conductor 11 (second linking conductor 12) in the first direction D1 is equal to or less than the length C1 of the first connecting conductor 9 (second connecting conductor 10) in the first direction D1 (C11≤C1). Thus, in the multilayer coil component 1, it is possible to inhibit an increase in stray capacitance formed between the second wiring portions 7 and each of the first linking conductor 11 and the second linking conductor 12.

In the multilayer coil component 1 according to the present embodiment, the length C2 of each of the first connecting conductor 9 and the second connecting conductor 10 in the third direction D3 is equal to or greater than the length P2 of the pillar portion 8 in the third direction D3 (C2≥P2). In this configuration, contact areas between the first terminal electrode 3 and the first connecting conductor 9 and between the second terminal electrode 4 and the second connecting conductor 10 can be further increased.

Although the embodiment of the present invention has been described above, the present invention is not necessarily limited to the above-described embodiment, and various modifications can be made without departing from the gist thereof.

In the above embodiment, an aspect in which the length C1 of the first connecting conductor 9 in the first direction D1 is the same as the length E1 of the first terminal electrode 3 in the first direction D1 (C1=E1) has been described as one example. However, the length C1 of the first connecting conductor 9 may be shorter than the length E1 of the first terminal electrode 3. Similarly, the length C1 of the second connecting conductor 10 may be shorter than the length E1 of the second terminal electrode 4.

In the above embodiment, an aspect in which the length C11 of the first linking conductor 11 in the first direction D1 is the same as the length C1 of the first connecting conductor 9 in the first direction D1 (C11=C1) has been described as one example. However, the length C11 of the first linking conductor 11 may be shorter than the length C1 of the first connecting conductor 9. Similarly, the length C11 of the second linking conductor 12 may be shorter than the length C1 of the second connecting conductor 10.

In the above embodiment, in the example shown in FIGS. 4 and 5, an aspect in which the length C2 of the first connecting conductor 9 in the third direction D3 is longer than the length P2 of the pillar portion 8 in the third direction D3 has been described as one example. However, the length C2 of the first connecting conductor 9 may be the same as the length P2 of the pillar portion 8 (C2=P2).

In the above embodiment, an aspect in which the first terminal electrode 3 and the second terminal electrode 4 protrude from the main surface 2d has been described as one example. However, the first terminal electrode 3 and the second terminal electrode 4 may be embedded within the element body 2. That is, the first terminal electrode 3 and the second terminal electrode 4 may be provided to be substantially flush with the main surface 2d. In this configuration, the plating layers provided on each of the first terminal electrode 3 and the second terminal electrode 4 may protrude from the main surface 2d.

What is claimed is:

1. A multilayer coil component comprising:
an element body that includes a pair of end surfaces opposite each other in a first direction, a mounting surface and a main surface opposite each other in a second direction, and a pair of side surfaces opposite each other in a third direction;
a pair of terminal electrodes disposed on the mounting surface of the element body to be separated from each other in the first direction;
a coil that is disposed in the element body and electrically connected to the pair of terminal electrodes; and
connecting conductors respectively electrically connecting one end portion and the other end portion of the coil to the pair of terminal electrodes,
wherein the coil includes first wiring portions disposed on the main surface side, second wiring portions disposed on the mounting surface side, and connecting portions that extend in the second direction and connect the first wiring portions to the second wiring portions,
the connecting conductors respectively connect the connecting portions that respectively constitute the one end portion and the other end portion of the coil to the terminal electrodes, and
lengths of the connecting conductors in the first direction are longer than lengths of the connecting portions connected to the connecting conductors in the first direction and are equal to or less than lengths of the terminal electrodes in the first direction.

2. The multilayer coil component according to claim 1,
wherein, when viewed in the second direction, each of the plurality of second wiring portions includes:
a first portion that includes a region overlapping the corresponding connecting portion, extends in the first direction, and is located closer to one end surface;
a second portion that includes a region overlapping the corresponding connecting portion, extends in the first direction, and is located closer to the other end face; and
a third portion that connects the first portion to the second portion and is inclined with respect to the first direction, and
lengths of the first portion and the second portion in the first direction may be longer than the lengths of the connecting conductors in the first direction.

3. The multilayer coil component according to claim 1, further comprising linking conductors disposed at the same positions as the second wiring portions in the second direction between the connecting conductors and the connecting portions electrically connected to the connecting conductors,
wherein lengths of the linking conductors in the first direction are equal to or less than the lengths of the connecting conductors in the first direction and are equal to or greater than the lengths of the connecting portions in the first direction.

4. The multilayer coil component according to claim 1, wherein lengths of the connecting conductors in the third direction are equal to or greater than lengths of the connecting portions in the third direction.
